(19) United States
(12) Patent Application Publication
(10) Pub. No.: US 2026/0333358 A1
(43) Pub. Date: Oct. 22, 2026

(54) SIMULTANEOUS UPLINK TRANSMISSION IN A COMMUNICATION NETWORK

(71) Applicant: Nokia Technologies Oy, Espoo (FI)

(72) Inventors: Sami-Jukka HAKOLA, Oulu (FI); Juha Pekka KARJALAINEN, Oulu (FI); Timo KOSKELA, Oulu (FI); Keeth Saliya Jayasinghe LADDU, Espoo (FI)

(21) Appl. No.: 19/119,314

(22) PCT Filed: Oct. 2, 2023
(86) PCT No.: PCT/EP2023/077217

§ 371 Date: Apr. 8, 2025

Related U.S. Application Data
(60) Provisional application No. 63/414,727, filed on Oct. 10, 2022.

(51) Int. Cl. H04W 72/21; H04B 17/318; H04W 52/14; H04W 52/36

(52) U.S. Cl. CPC H04W 72/21; H04B 17/328; H04W 52/146; H04W 52/367

(57) ABSTRACT

An apparatus performs identifying or detecting that simultaneous transmissions of at least two uplink channels from the apparatus are to be overlapped at least in part. The apparatus also performs managing the simultaneous transmissions of the at least two uplink channels based on the identification or detection. For two UL channels, these could be PUCCH, PUSCH, or PUCCH and PUCCH. The simultaneous transmissions could be from a UE to two (or more) TRPs. The applications of this include using a unified TCI framework.

### TECHNICAL FIELD

Exemplary embodiments herein relate generally to wireless communications and, more specifically, relates to simultaneous uplink (UL) transmissions, e.g., using multiple antenna panels, from user equipment (UE) in a communication network.

### BACKGROUND

A user equipment (UE) is a device allowing a user access to network services. The UE may connect to a wireless network, for example, for the network services through connection devices such as transmission-reception points (TRPs). A TRP is a Transmit/Receive (TX/RX) unit that can have a large number of TX/RX antenna elements generating directional beams. The TRP will be transparent to the UE, since the UE sees mobility only between beams (Beam Mobility). Thus, from a UE point of view, a TRP can be seen as a one or multiple downlink reference signals that the UE is able to detect and measure, or via configured coreset pool index to which set of signals and channels are associated. For UEs that can support multiple uplink (UL) communications, such as through multiple antenna panels, the UE could be communicating with multiple TRPs in a multi-TRP (multiple-TRP) operation. This allows the UE to simultaneously communicate with two or more TRPs, for instance. An antenna panel may be characterized and identified by a logical index where each index may be associated to certain capability/capabilities and/or parameters of the antenna panel such like number of antenna ports (the antenna panel supports), Tx power/EIRP, number of beams it can generate, for instance.

In UL, a UE will use a physical uplink control channel (PUCCH) to transmit control information to a TRP and use a physical uplink shared channel (PUSCH) to transmit (user) data to the same TRP or a different TRP. There can be issues when the UE is communicating in UL, e.g., with its multiple antenna panels and with multiple TRPs, and transmitting UL information via different PUCCHs, or via different PUSCHs, or via a PUCCH and a PUSCH.

### BRIEF SUMMARY

This section is intended to include examples and is not intended to be limiting.

In an exemplary embodiment, a method is disclosed that includes identifying or detecting that simultaneous transmissions of at least two uplink channels from an apparatus are to be overlapped at least in part. The method also includes managing the simultaneous transmissions of the at least two uplink channels based on the identification or detection.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories storing instructions that, when executed by the one or more processors, cause the apparatus at least to perform: identifying or detecting that simultaneous transmissions of at least two uplink channels from the apparatus are to be overlapped at least in part; and managing the simultaneous transmissions of the at least two uplink channels based on the identification or detection.

An exemplary computer program product includes a computer-readable storage medium bearing computer program code embodied therein for use with a computer. The computer program code includes: code for identifying or detecting that simultaneous transmissions of at least two uplink channels from the apparatus are to be overlapped at least in part; and code for managing the simultaneous transmissions of the at least two uplink channels based on the identification or detection.

In another exemplary embodiment, an apparatus comprises means for performing: identifying or detecting that simultaneous transmissions of at least two uplink channels from the apparatus are to be overlapped at least in part; and managing the simultaneous transmissions of the at least two uplink channels based on the identification or detection.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2A illustrates an example of a multi-TRP communication with a UE having two antenna panels;

FIG. 2B illustrates the example of FIG. 2A, after a rotation on the UE has been performed;

FIG. 3 is split over FIGS. 3A and 3B and is a logic flow diagram for simultaneous uplink transmission in a communication network, and illustrates the operation of an exemplary method or methods, a result of execution of computer program instructions embodied on a computer readable memory, functions performed by logic implemented in hardware, and/or interconnected means for performing functions in accordance with exemplary embodiments; and

FIG. 4 is a logic flow diagram performed by a UE for simultaneous uplink transmission in a communication network, and illustrates the operation of an exemplary method or methods, a result of execution of computer program instructions embodied on a computer readable memory, functions performed by logic implemented in hardware, and/or interconnected means for performing functions in accordance with exemplary embodiments.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as either “or”, “and”, or “both”.

Exemplary embodiments herein are related to 3GPP New Radio (NR) physical layer development in Rel-18. More specifically, this document focuses on facilitating simultaneous PUCCH transmissions from two UE transmit antenna panels in multi-DCI (m-DCI) multi-TRP (mTRP) scenario. Additional description of these embodiments is presented after a system into which the exemplary embodiments may be used is described.

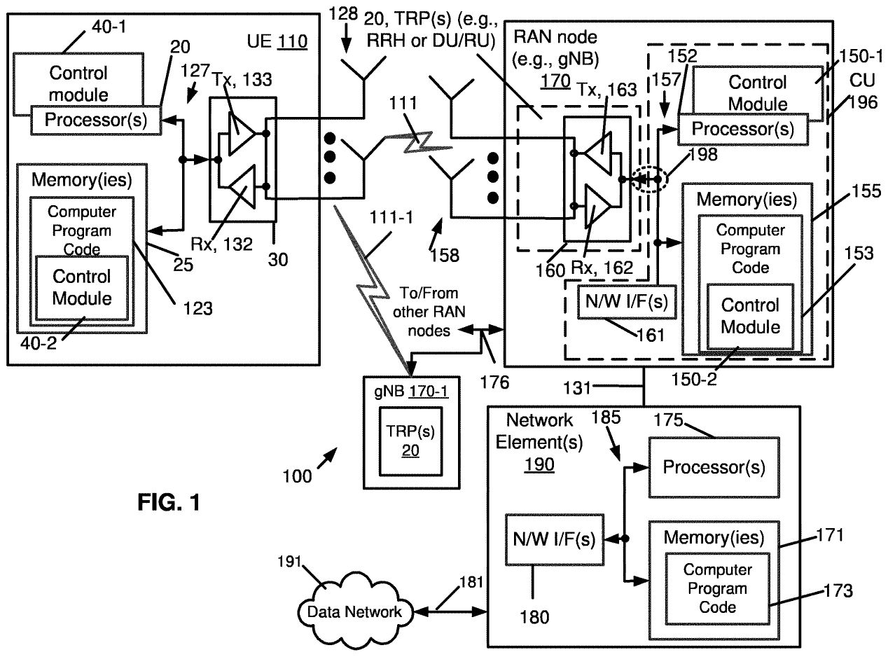

Turning to FIG. 1, this figure shows a block diagram of one possible and non-limiting exemplary system in which the exemplary embodiments may be practiced. A user equipment (UE) 110, radio access network (RAN) node 170, and network element(s) 190 are illustrated. In FIG. 1, a user equipment (UE) 110 is in wireless communication with a wireless network 100. The RAN node 170 is commonly called a gNB for 5G, although the RAN node is not limited to a gNB, as described in more detail below. The RAN node 170 has one or multiple TRPs 20, which may have different configurations depending on radio access technology being used. The UE 110 communicates with the gNB 170 via a wireless link 170. In one scenario, the UE 110 communicates with multiple TRPs 20 from the same gNB, gNB 170. In another scenario, another gNB 170-1 may be used, and it may have its own set of one or more TRPs 20. If the UE communicates with the second gNB 170-1, the UE 110 uses the wireless link 110-1 for this purpose. The gNB 170 is assumed to be a serving cell, and the gNB 170-1 is assumed to be a secondary cell in this scenario.

A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a control module 140, comprising one of or both parts 140-0 and/or 140-1, which may be implemented in a number of ways. The control module 140 may be implemented in hardware as control module 140-0, such as being implemented as part of the one or more processors 120. The control module 140-0 may be implemented also as an integrated circuit or through other hardware such as a programmable gate array. In another example, the control module 140 may be implemented as control module 140-1, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node (e.g., gNB) 170 is a base station that provides access by wireless devices such as the UE 110 to the wireless network 100. It is assumed the gNBs 170 and 170-1 are similar, and only the circuitry of the RAN node 170 is described. The RAN node 170 may be, for instance, a base station for 5G, also called New Radio (NR). In 5G, the RAN node 170 may be a NG-RAN node, which is defined as either a gNB or an ng-eNB. A gNB is assumed herein. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs). Note that the DU may include or be coupled to and control a radio unit (RU). The DUs (or RUs) are examples of TRPs 20. The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU (as a TRP 20). The gNB-DU is a logical node hosting RLC, MAC and PHY layers of the gNB or en-gNB, and its operation is partly controlled by gNB-CU. One gNB-CU supports one or multiple cells. One cell is supported by one gNB-DU. The gNB-DU terminates the F1 interface 198 connected with the gNB-CU. Note that the DU is considered to include the transceiver 160, e.g., as part of an RU, but some examples of this may have the transceiver 160 as part of a separate RU, e.g., under control of and connected to the DU. The RAN node 170 may also be an eNB (evolved NodeB) base station, for LTE (long term evolution), or any other suitable base station.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the TRP 20 may also contain its own memory/memories and processor(s), and/or other hardware, but these are not shown.

The RAN node 170 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the control module 150 may be distributed, such as being distributed between the DU (as a TRP 20) and the CU 196, or be implemented solely in the DU.

The one or more network interfaces 161 communicate over a network such as via the links 176 and 131. Two or more RAN nodes 170 communicate using, e.g., link 176. The link 176 may be wired or wireless or both and may implement, e.g., an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) as a TRP 20 for LTE or a distributed unit (DU) as a TRP 20 for gNB implementation for 5G, with the other elements of the RAN node 170 possibly being physically in a different location from the RRH/DU, and the one or more buses 157 could be implemented in part as, e.g., fiber optic cable or other suitable network connection to connect the other elements (e.g., a central unit (CU), gNB-CU) of the RAN node 170 to the TRP (e.g., RRH/DU) 20. Reference 198 also indicates those suitable network link(s).

The wireless network 100 may include a network element or elements 190 that may include core network functionality, and which provides connectivity via a link or links 181 with a data network 191, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor-based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general-purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, vehicles with a modem device for wireless V2X (vehicle-to-everything) communication, image capture devices such as digital cameras having wireless communication capabilities, gaming devices having wireless communication capabilities, music storage and playback appliances having wireless communication capabilities, Internet appliances (including Internet of Things, IoT, devices) permitting wireless Internet access and possibly browsing, IoT devices with sensors and/or actuators for automation applications with wireless communication tablets with wireless communication capabilities, as well as portable units or terminals that incorporate combinations of such functions.

Having thus introduced one suitable but non-limiting technical context for the practice of the exemplary embodiments, the exemplary embodiments will now be described with greater specificity.

As described above, there can be issues when the UE is performing simultaneous transmissions over different PUCCHs, or different PUSCHs, or PUCCH+PUSCH to one or more TRPs such as, for example, in multi-DCI (m-DCI) multi-TRP (mTRP) scenario, using multiple transmit antenna panels of the UE. An overview of the technical area and its possible issues is now provided.

Rel-18 is developing means to enable a UE to transmit simultaneously two PUCCHs from different UE antenna panels as described in Rel-18 MIMO Work Item as indicated below [RP-213598]:

RAN1:
. . .
6. Study, and if needed, specify the following items to facilitate simultaneous multi-
panel UL transmission for higher UL throughput/reliability, focusing on FR2 and
multi-TRP, assuming up to 2 TRPs and up to 2 panels, targeting
CPE/FWA/vehicle/industrial devices (if applicable)
UL precoding indication for PUSCH, where no new codebook is introduced
for multi-panel simultaneous transmission
The total number of layers is up to four across all panels and total number of
codewords is up to two across all panels, considering single DCI and multi-
DCI based multi-TRP operation.
UL beam indication for PUCCH/PUSCH, where unified TCI framework
extension in objective 2 is assumed, considering single DCI and multi-DCI
based multi-TRP operation
For the case of multi-DCI based multi-TRP operation, only
PUSCH + PUSCH, or PUCCH + PUCCH is transmitted across two panels in
a same CC.
. . .

That is, there can be multi-panel uplink transmissions for higher UL throughput/reliability, focusing on FR2 and multi-TRP, assuming up to two TRPs and up to two antenna panels. This entails using a unified TCI framework extension, and one option is PUCCH+PUCCH being transmitted across two antenna panels in a same CC.

It is noted that, from a UE point of view, a TRP can be seen as a one or multiple downlink reference signals the UE is able to detect and measure, or via configured coreset pool index to which set of signals and channels are associated.

This is an improvement on the Rel-17 unified TCI framework, which is now described. Rel-17 is introducing a unified TCI framework meaning that TCI states so far providing QCL assumptions for the reception of DL signals and channels would be used also to provide spatial sources for the transmission of UL signals and channels. Furthermore, the unified TCI framework defines the concept of indicated TCI state. The indicated TCI state can be joint DL and UL TCI state or separate DL and separate UL TCI states. Indicated TCI state provides QCL source (DL) and spatial source (UL) for the set of downlink signals and channels and for the set of uplink signals and channels, respectively. In Rel-17 there can be one indicated joint DL and UL or one indicated DL and one indicated UL TCI state for the UE.

The unified TCI framework comprises the following functionalities at a high level:

1) Common TCI state (a.k.a. indicated TCI) for a set of signals and channels at a time.

2) TCI state can be joint DL/UL, separate DL TCI state, and separate UL TCI state.

3) RRC configures a set (or pool) of joint and/or separate TCI states.

4) MAC activates a number (e.g., 8) of joint and/or separate TCI states.

a) Before first indication, a first activated TCI state is the current indicated TCI state. In more detail, before the UE has received TCI selection (e.g., indication) in DCI, the current indicated TCI state is the first activated TCI state that has been activated by MAC. Order of sequence is that first TCI states are configured in RRC, then one or more are activated by MAC, and then selection/indication from the activated ones by DCI.

5) DCI indicates one of the activated TCI states to be indicated TCI state (which may be a common TCI state).

On the DCI-based TCI state indication, the following has been agreed so far:

1) DCI format 1_1/1_2 with and without DL assignment is used to carry the TCI state indication.

2) The indication is confirmed by HARQ ACK by the UE.

3) Application time of the beam indication, which may be the first slot that is at least X ms or Y symbols after the last symbol of the acknowledgment of the joint or separate DL/UL beam indication.

4) TCI field codepoint:

a) Joint, which may include TCI state for both DL and UL.

b) Separate:

i) a pair of DL TCI state and UL TCI state;

ii) a DL TCI state (keep the current UL TCI state); or

iii) an UL TCI state (keep the current DL TCI state).

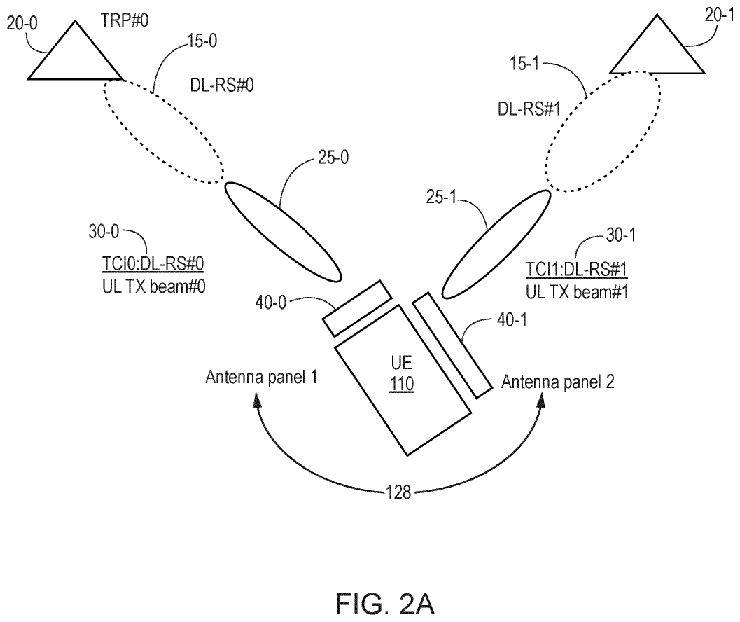

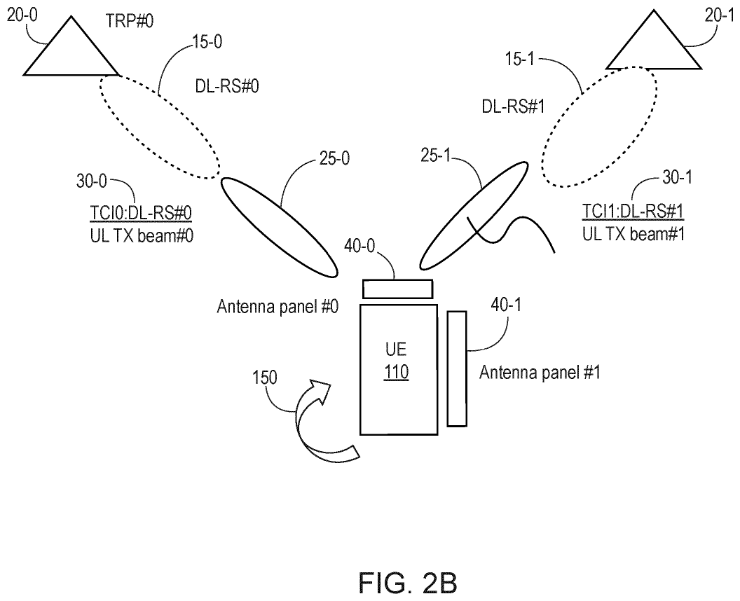

Now that the Rel-17 unified TCI framework has been described, additional technical overview is provided. Intention in the PUCCH+PUCCH simultaneous transmissions is that each PUCCH would be transmitted using a different panel (see FIG. 2A). FIG. 2A illustrates a multi-TRP communication with a UE having two antenna panels. The UE 110 has a first antenna panel 1 40-0 and a second antenna panel 2 40-1, which comprise some or all of the antennas 128 (see FIG. 1). The UE 110 uses antenna panel 1 40-0 to communicate in UL using UL TX beam #0 25-0 with the TRP #0 20-0. TRP #0 20-0 uses the DL beam 15-0, which is associated with the DL-RS #0, to communicate with the UE 110. There is a TCI0 30-0 that indicates a spatial source DL-RS #0. The UE uses antenna panel 2 40-1 to communicate using UL TX beam #1 25-1 with the TRP #1 20-1. TRP #1 20-1 uses the DL beam 15-1, which is associated with the DL-RS #1, to communicate with the UE 110. There is a TCI1 30-1 that indicates spatial source DL-RS #1.

It is noted that an antenna panel may be characterized and identified by a logical index, where each index may be associated to certain capability/capabilities and/or parameters of the panel, such as a number of antenna ports (which the panel supports), Tx power/EIRP, number of beams the panel can generate, for instance.

However, during the operation, the UE may rotate so that one panel would be serving both beam pair links between the UE and two receiving TRPs. In other words, one panel may be oriented towards both TRPs while the other UE panel is oriented to the direction the TRPs are not located. See FIG. 2B, where due to rotation 150, only the antenna panel #0 40-0 is directed to both the beams for TRP #0 and TRP #1 and antenna panel #1 40-1 is oriented in a direction where there are no TRPs 20. Thus, in this situation, in order to have feasible beam-pair link quality, one of the antenna panels would be used towards both receiving TRPs. In the current NR system, the network is not aware of which panel the UE is using or would be using for the certain PUCCH transmission. That is, the UE is only provided a spatial source reference signal, e.g., via TCI state (e.g., in FIG. 2A, TCI 0 indicates a spatial source DL-RS #0) or indicated TCI state that comprises the QCL-TypeD RS based on which the UE forms its transmit spatial filter.

In addition, the total transmitted power and/or EIRP when transmitting simultaneously with two panels may exceed the maximum allowed transmission power/EIRP and thus transmit power scaling would be needed.

3GPP TS 38.213, section 9.2.5 defines the UE behavior for the overlapping PUCCHs. However, the considered rules including potential multiplexing, dropping and power scaling, do not take into account the mapping of PUCCHs across multiple UE panels. In addition, as can be seen from the following specification excerpt, the current NR (up to Rel-17) does not support multiple simultaneous PUCCH transmissions triggered in a multi-DCI multi-TRP scenario:

A UE that
is not provided coresetPoolIndex or is provided coresetPoolIndex with a value of 0
for first CORESETs on active DL BWPs of serving cells, and
is provided coresetPoolIndex with a value of 1 for second CORESETs on active DL
BWPs of the serving cells, and
is provided ackNackFeedbackMode = separate
does not expect a PUCCH or a PUSCH transmission triggered by a detection of a DCI format
in a PDCCH received in a CORESET from the first CORESETs to overlap in time with a
PUCCH or a PUSCH transmission triggered by a detection of a DCI format in a PDCCH
received in a CORESET from the second CORESETs.

To address these problems, a framework is considered herein for the simultaneous uplink transmissions such as, for example, PUCCH+PUCCH, or PUSCH+PUSCH, or a hybrid (e.g., PUCCH+PUSCH) transmissions, that provides UE rules or behaviors for the different situations described above when potentially the UE would need to drop transmission(s) of one of the simultaneous uplink transmissions or to scale the transmit power/EIRP in certain way. A multi-stage (e.g., two-stage is the main example) method is proposed in an example for the UE to determine its behavior to manage the simultaneous uplink transmissions, for example, the overlapping two PUCCH transmission occasions, or two PUSCH transmission occasions, or two PUCCH+PUSCH transmission occasions, and this is divided into two broad steps.

1) In a first step, validation status of an association between indicated TCI states and different antenna panels of the UE is determined.

After the UE has determined that there will be overlapping uplink transmissions such as overlapping PUCCH+PUCCH transmissions, for example, the UE determines whether the UE is able to transmit the two different PUCCHs simultaneously, i.e., using two (or more) different antenna panels of the UE, according to the current indicated TCI states for the different PUCCHs.

In this determination step, the UE evaluates which transmit antenna panel to associate to which indicated TCI states based on power threshold and L1-RSRP measurement associated with indicated TCI state. Based on this, the UE determines whether there is a one-to-one mapping between indicated TCI-states and different transmit antenna panels of the UE. For example, the one-to-one mapping defines or specifies that the one or more indicated TCI states each correspond to a different one of the one or more transmit antenna panels associated with the UE.

When the one-to-one mapping is determined, the association status between indicated TCI states and different transmit antenna panels is defined or considered as valid for use for the overlapping uplink transmissions. Otherwise, the association status is defined or considered as invalid for use for the overlapping uplink transmissions.

That is, the UE maintains indicated TCI states associated to different transmit antenna panels as valid for use for the overlapping uplink transmissions, until measured L1-RSRP associated DL resource of indicate TCI state is higher or equal than a power threshold (configured or predetermined) for the UE; otherwise, the UE determines the status of transmit antenna panel association with indicated TCI states as invalid for use for the overlapping uplink transmissions. In this regard, UE would determine whether associated beam pair links in uplink to different TRPs would be carried out by two different antenna panels or by the same (single) antenna panel associated with the UE. The UE may do that by comparing the L1-RSRP measurements per antenna panel, where each L1-RSRP measurement is performed for the DL RSs of the indicated TCI states that are to characterize the beam pair links between the UE (antenna panels) and TRPs. In various embodiments, the UE may measure DL RSs using both antenna panels (assuming the UE would use the same beam for uplink transmission as for downlink reception of DL RS and thus for measurement). The UE may compare the L1-RSRP results and evaluate whether corresponding RSRP results are strong enough for both beam pair links from different antenna panels, then the UE determines that it can transmit simultaneously from both antenna panels. Otherwise, the UE determines that both beam pair links are to be transmitted from the same antenna panel and thus simultaneous transmission is not preferable.

2) In a second step, an association status is defined or considered as invalid for use for the overlapping uplink transmissions.

If the UE is not able to transmit both PUCCHs, for example, using different transmit antenna panels associated with the UE, the UE evaluates which one of the PUCCHs to transmit, as follows.

a) If the priority indices of the PUCCHs are not equal, the UE drops the one with higher priority index. It is noted that higher priority index means lower priority.

b) Otherwise, the UE transmits the PUCCH that is associated to the lower coresetPoolIndex. As is known, coresetpoolindex is an index for a set of coresets (control resource sets) and in practice is an index for a TRP. Here, prioritization is being performed according to coresetPoolIndex (where the lower the index, the higher the priority), although other indexes or information may be used for prioritization.

c) If the PUCCH transmission is associated CORESETpoolindex that is determined to be in beam failure condition or has failed (the CORESETs of CORESETpoolindex are monitored using BFD-RS set associated with the CORESETPoolIndex) the UE drops the PUCCH associated with the CORESETpoolindex of the failed BFD-RS set.

d) In one example, if one of the PUCCH carries an SR transmission, this transmission may be prioritized over the other PUCCH.

i) Prioritization may be determined based on the SR type or association information the SR provides.

ii) If the SR is used for beam failure recovery/LBT failure indication, the transmission with the SR may be prioritized.

In one example, if one of the PUCCH carries A/N feedback for DL retransmission it may be prioritized, e.g., prioritized over PUCCH carrying A/N feedback for the first transmission.

In one example, the priority may be based on the time type for the PUCCH transmission, e.g., the aperiodic/scheduled PUCCH may be prioritized over periodic PUCCH.

This ends the discussion of step 2.

With respect to these steps, if the UE is able to transmit both PUCCHs, the UE evaluates the total required Tx power/EIRP, as follows.

i) If the required Tx power/EIRP does not exceed the maximum allowed, the UE transmits two PUCCHs.

ii) Otherwise, the UE performs TX power scaling with the following options (select one of them to use):
A) Perform equal power scaling;
B) Perform un-equal power scaling so that the UE performs power scaling to PUCCH associated to higher coresetPoolIndex; or
C) Drop PUCCH associated to higher coresetPoolIndex.

In the above, although overlapping PUCCH+PUCCH transmissions are considered on how the UE determines whether the UE is able to transmit simultaneously, i.e., using two (or more) different transmit antenna panels, according to the current indicated TCI states for the overlapping transmissions. The same may be applied to other overlapping uplink transmissions such as, for example, overlapping PUSCH+PUSCH or PUCCH+PUSCH transmissions from the UE using two (or more) different transmit antenna panels associated with the UE.

In one embodiment, if the UE determines that there is a possibility for overlapping uplink transmissions such as, for example, PUCCH+PUCCH or PUSCH+PUSCH or PUCCH+PUSCH transmissions from two (or more) different transmit antenna panels of the UE, the UE may trigger (e.g., an aperiodic or a dynamic) uplink report, e.g., wherein the report may comprise an indication that more than one uplink transmissions/TCI states of the UE are associated with the same UE antenna panel associated with the UE.

In one example, with overlapping PUCCH+PUCCH transmissions, for example, the PUCCH that start earlier in time may be prioritized. Here, PUCCH transmissions are partially overlapping and the first PUCCH transmission in time may be continued while the other one is dropped. With overlapping PUCCH+PUSCH transmissions, the PUCCH or PUSCH that start earlier in time may be prioritized. Here, PUCCH+PUSCH transmissions are partially overlapping and the first PUCCH or PUSCH transmission in time may be continued while the other one is dropped. Similarly, with overlapping PUSCH+PUSCH transmissions, the PUSCH that start earlier in time may be prioritized. Here, PUSCH transmissions are partially overlapping and the first PUSCH transmission in time may be continued while the other one is dropped.

In one example, with overlapping PUCCH+PUCCH transmissions, the PUCCH that has a repetition operation in time (TDMed PUCCH towards one TRP or both TRPs) or a higher number of repetitions may be de-prioritized. That is, a one-shot PUCCH transmission is prioritized over the PUCCH transmission that is part of the repeated PUCCH transmissions. Here, the PUCCH repetitions may have at least one other repetition instance that may not overlap with the PUCCH transmission towards other TRP.

It is noted that multi-TRP is used as a primary example herein, but the techniques described herein are not limited to multi-TRP. Furthermore, while a unified TCI framework is a main example, the description takes unified TCI only as an example. Additionally, while some examples use antenna panels, other antenna systems in UEs that are able to communicate in UL with multiple reception points may be used.

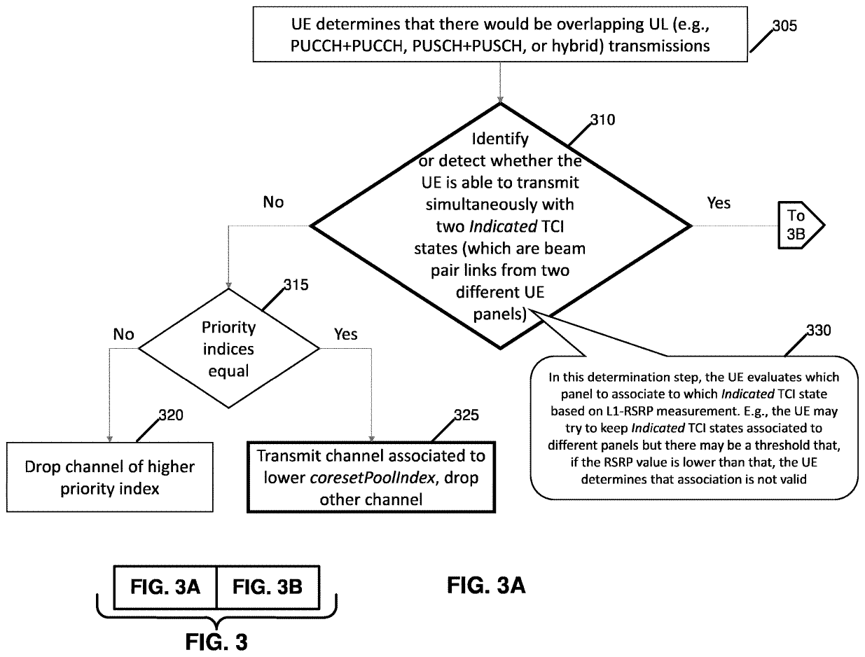

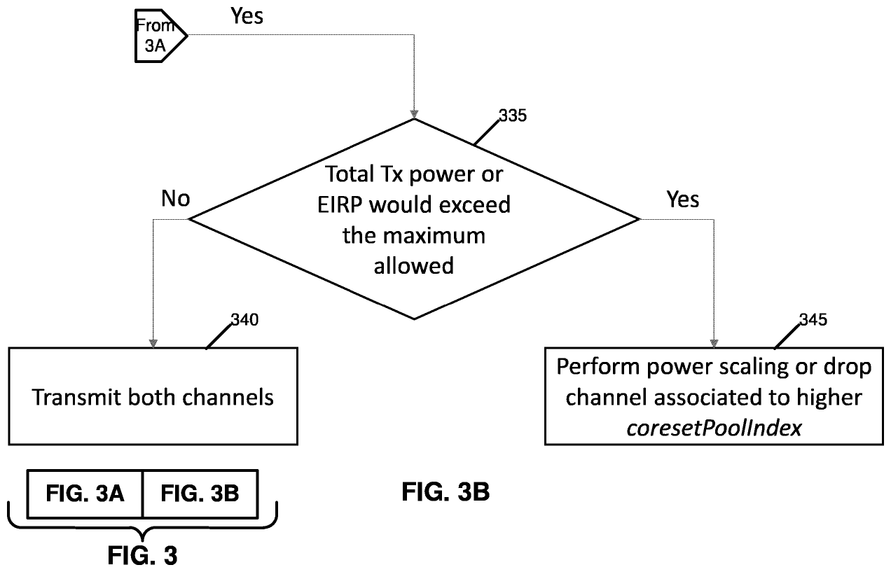

Referring to FIG. 3, which is split over FIGS. 3A and 3B, this figure is a logic flow diagram for simultaneous uplink transmission in a communication network. This example is related to multi-stage rules for simultaneous UL (e.g., PUCCH+PUCCH or PUSCH+PUSCH or PUCCH+PUSCH) transmissions for use in multi-TRP scenario under a unified TCI Framework. This figure also illustrates the operation of an exemplary method or methods, a result of execution of computer program instructions embodied on a computer readable memory, functions performed by logic implemented in hardware, and/or interconnected means for performing functions in accordance with exemplary embodiments. The blocks in this flow diagram are performed by the UE 110. FIG. 3 contains a lot of the material described above, but in the form of a logic flow diagram.

In block 305, the UE determines that there would be overlapping (e.g., at least in part) uplink transmissions. Note that this overlapping is considered to mainly in time, although it is possible for frequency to play a role. These uplink transmissions may be PUCCH+PUCCH, PUSCH+PUSCH, or hybrid, e.g., PUCCH+PUSCH. In block 310, the UE identifies or detects whether it is able to transmit simultaneously with two indicated TCI states (which are beam pair links from two different UE transmit antenna panels). Block 330 further defines block 310. Block 330 indicates that, in the determination step of 310, the UE evaluates which transmit antenna panel to associate to which indicated TCI state based on L1-RSRP measurement. E.g., the UE may try to keep indicated TCI states associated to different transmit antenna panels, but there may be a threshold that, if the RSRP value is lower than that, the UE determines that association is not valid for use for the overlapping uplink transmissions. It is noted that the terms “identify”, “detect”, or “determine” in these steps are assumed to be similar or the same, and indicate the UE is making a decision as to whether the UE is able to transmit two (or more) transmissions simultaneously in uplink.

If not (block 310=No), the UE in block 315 determines if the priority indices are equal, where priority index means here explicitly configured priority indices to different channels in RRC. If the priority indices are not equal (block 315=No), the UE drops the channel of the higher priority index in block 320 in case of the overlapping channel (e.g., PUCCH+PUCCH, PUSCH+PUSCH, or hybrid, PUCCH+PUSCH) transmissions. If the priority indices are equal (block 315=Yes), the UE transmits the channel associated to the lower coresetPoolIndex, and drops the other channel in block 325.

In block 310, if the UE determines it is able to transmit simultaneously with two indicated TCI states (block 310=Yes), the flow proceeds to block 335, where the UE determines whether total Tx power or EIRP would exceed the maximum allowed for the UE. If not (block 335=No), then the UE in block 340 transmits information on both channels. If so (block 335=Yes), the UE in block 345 performs power scaling or drops a channel associated to the higher coresetPoolIndex.

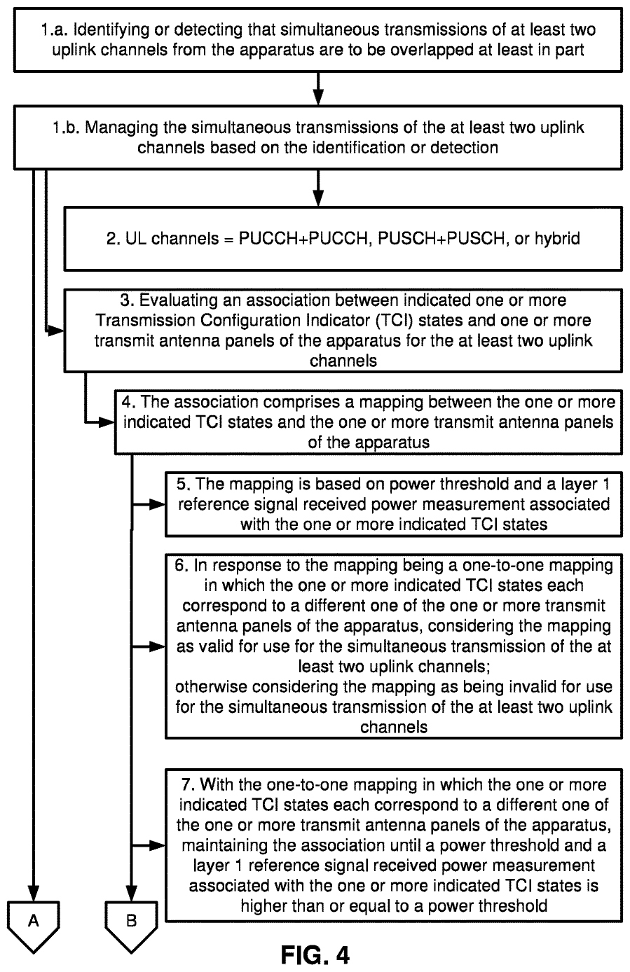

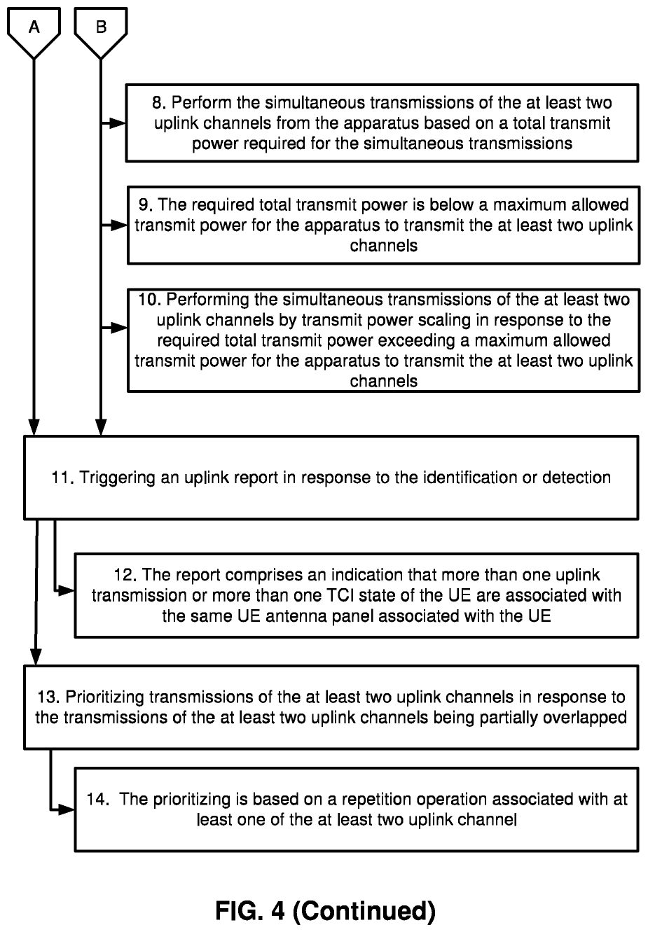

FIG. 4 is a logic flow diagram performed by a UE for simultaneous uplink transmission in a communication network. FIG. 4 also illustrates the operation of an exemplary method or methods, a result of execution of computer program instructions embodied on a computer readable memory, functions performed by logic implemented in hardware, and/or interconnected means for performing functions in accordance with exemplary embodiments.

In step 1.a, the UE performs identifying or detecting that simultaneous transmissions of at least two uplink channels from the apparatus are to be overlapped at least in part. The UE, in step 1b, performs managing the simultaneous transmissions of the at least two uplink channels based on the identification or detection. Steps 1a and 1b are collectively referred to below as step 1.

Step 2. This step relates to step 1, wherein the at least two uplink channels comprise two different uplink control channels, or two different uplink data channels, or a hybrid of an uplink control channel and an uplink data channel.

Step 3. This step refers to steps 1 or 2, wherein the managing the simultaneous transmissions further comprises evaluating an association between one or more indicated Transmission Configuration Indicator (TCI) states and one or more transmit antenna panels of the apparatus for the at least two uplink channels.

Step 4. This step refers to step 3, wherein the association comprises a mapping between the one or more indicated TCI states and the one or more transmit antenna panels of the apparatus.

Step 5. This step refers to step 4, wherein the mapping is based on power threshold and a layer 1 reference signal received power measurement associated with the one or more indicated TCI states.

Step 6. This step refers to steps 4 or 5, wherein the managing the simultaneous transmissions further comprises:

in response to the mapping being a one-to-one mapping in which the one or more indicated TCI states each correspond to a different one of the one or more transmit antenna panels of the apparatus, considering the mapping as valid for use for the simultaneous transmission of the at least two uplink channels; and

otherwise considering the mapping as being invalid for use for the simultaneous transmission of the at least two uplink channels.

Step 7. This step refers to any of steps 4 to 6, wherein the managing the simultaneous transmissions further comprises:

with the one-to-one mapping in which the one or more indicated TCI states each correspond to a different one of the one or more transmit antenna panels of the apparatus, maintaining the association until a power threshold and a layer 1 reference signal received power measurement associated with the one or more indicated TCI states is higher than or equal to a power threshold.

Step 8. This step refers to steps 6 or 7, wherein the managing the simultaneous transmissions further comprises: perform the simultaneous transmissions of the at least two uplink channels from the apparatus based on a total transmit power required for the simultaneous transmissions.

Step 9. This step refers to any of steps 6 to 8, wherein the required total transmit power is below a maximum allowed transmit power for the apparatus to transmit the at least two uplink channels.

Step 10. This step refers to any of steps 6 to 8, wherein the managing the simultaneous transmissions further comprises: performing the simultaneous transmissions of the at least two uplink channels by transmit power scaling in response to the required total transmit power exceeding a maximum allowed transmit power for the apparatus to transmit the at least two uplink channels.

Step 11. This step refers to any of steps 1 to 10, wherein triggering an uplink report in response to the identification or detection.

Step 12. This step refers to step 11, wherein the report comprises an indication that more than one uplink transmission or more than one TCI state of the UE are associated with the same UE antenna panel associated with the UE.

Step 13. This step refers to any of steps 1 to 12, wherein the managing the simultaneous transmissions further comprises: prioritizing transmissions of the at least two uplink channels in response to the transmissions of the at least two uplink channels being partially overlapped.

Step 14. This step refers to step 13, wherein the prioritizing is based on a repetition operation associated with at least one of the at least two uplink channels

Without in any way limiting the scope, interpretation, or application of the claims appearing below, a technical effect and advantage of one or more of the example embodiments disclosed herein is One benefit is that in all conditions we can at least transmit higher priority uplink control information to the network.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3GPP third generation partnership project
5G fifth generation
5GC 5G core network
a.k.a. also known as
AMF access and mobility management function
A/N Ack (acknowledge)/Nack (negative acknowledge)
BFD-RS beam failure detection-reference signal
CC component carrier
CORESET control resource set
CU central unit
DCI Downlink Control Information
DL downlink
DU distributed unit
EIRP Equivalent isotropically radiated power
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FR2 frequency range 2
HARQ hybrid automatic retransmission reQuest
gNB (or gNodeB) base station for 5G/NR, i.e., a node providing NR user plane and control plane protocol terminations towards the UE, and connected via the NG interface to the 5GC
I/F interface
L1 layer 1
LBT listen before talk
LTE long term evolution
m-DCI multi-DCI
MAC medium access control
MIMO multiple input, multiple output
MME mobility management entity
ms millisecond
multi multiple
ng or NG next generation
ng-eNB or NG-eNB next generation eNB
NR new radio
N/W or NW network
PDCP packet data convergence protocol
PHY physical layer
PUCCH Physical Uplink Control Channel
PUSCH physical uplink shared channel
QCL
RAN radio access network
Rel release
RRC radio resource control
RRH remote radio head
RS reference signal
RSRP Reference Signal Received Power
Rx receiver or receive
SDAP service data adaptation protocol
SGW serving gateway
SMF session management function
SR scheduling request
TCI Transmission Coordination Indicator
TDM time division multiplex
TRP transmission-reception point
TS technical specification
Tx transmitter or transmit
UE user equipment (e.g., a wireless, typically mobile device)
UL uplink
UPF user plane function

1-46. (canceled)

47. An apparatus for communication, comprising:
one or more processors; and
one or more memories storing instructions that, when executed by the one or more processors, cause the apparatus at least to:
identify or detecting that simultaneous transmissions of at least two uplink channels from the apparatus are to be overlapped at least in part; and
manage the simultaneous transmissions of the at least two uplink channels based on the identification or detection.

48. The apparatus of claim 47, wherein the at least two uplink channels comprise two different uplink control channels, or two different uplink data channels, or a hybrid of an uplink control channel and an uplink data channel.

49. The apparatus of claim 47, wherein the managing the simultaneous transmissions further comprises the apparatus caused to:
evaluate an association between one or more indicated Transmission Configuration Indicator (TCI) states and one or more transmit antenna panels of the apparatus for the at least two uplink channels.

50. The apparatus of claim 49, wherein the association comprises a mapping between the one or more indicated TCI states and the one or more transmit antenna panels of the apparatus.

51. The apparatus of claim 50, wherein the mapping is based on power threshold and a layer 1 reference signal received power measurement associated with the one or more indicated TCI states.

52. The apparatus of claim 50, wherein the managing the simultaneous transmissions further comprises the apparatus caused to:
in response to the mapping being a one-to-one mapping in which the one or more indicated TCI states each correspond to a different one of the one or more transmit antenna panels of the apparatus, consider the mapping as valid for use for the simultaneous transmission of the at least two uplink channels; and
otherwise consider the mapping as being invalid for use for the simultaneous transmission of the at least two uplink channels.

53. The apparatus of claim 47 wherein the managing the simultaneous transmissions further comprises the apparatus caused to:
with the one-to-one mapping in which the one or more indicated TCI states each corresponds to a different one of the one or more transmit antenna panels of the apparatus, maintain the association until a power threshold and a layer 1 reference signal received power measurement associated with the one or more indicated TCI states is higher than or equal to a power threshold.

54. The apparatus of claim 52, wherein the managing the simultaneous transmissions further comprises the apparatus caused to:
perform the simultaneous transmissions of the at least two uplink channels from the apparatus based on a total transmit power required for the simultaneous transmissions.

55. The apparatus of claim 52, wherein the required total transmit power is below a maximum allowed transmit power for the apparatus to transmit the at least two uplink channels.

56. The apparatus of claim 52, wherein the managing the simultaneous transmissions further comprises the apparatus caused to:
perform the simultaneous transmissions of the at least two uplink channels by transmit power scaling in response to the required total transmit power exceeding a maximum allowed transmit power for the apparatus to transmit the at least two uplink channels.

57. The apparatus of claim 47, wherein the instructions, when executed by the at least one processor, cause the apparatus at least to:
triggering an uplink report in response to the identification or detection.

58. The apparatus of claim 57, wherein the report comprises an indication that more than one uplink transmission or more than one TCI state of the UE are associated with the same UE antenna panel associated with the UE.

59. The apparatus of claim 47, wherein the managing the simultaneous transmissions further comprises the apparatus caused to:
prioritize transmissions of the at least two uplink channels in response to the transmissions of the at least two uplink channels being partially overlapped.

60. The apparatus of claim 59, wherein the prioritizing is based on a repetition operation associated with at least one of the at least two uplink channels.

61. A method for communication, comprising:
identifying or detecting by an apparatus, that simultaneous transmissions of at least two uplink channels from the apparatus are to be overlapped at least in part; and
managing by the apparatus, the simultaneous transmissions of the at least two uplink channels based on the identification or detection.

62. The method of claim 61, wherein the at least two uplink channels comprise two different uplink control channels, or two different uplink data channels, or a hybrid of an uplink control channel and an uplink data channel.

63. The method of claim 61, wherein the managing the simultaneous transmissions further comprises:
evaluating an association between one or more indicated Transmission Configuration Indicator (TCI) states and one or more transmit antenna panels of the apparatus for the at least two uplink channels.

64. The method of claim 63, wherein the association comprises a mapping between the one or more indicated TCI states and the one or more transmit antenna panels of the apparatus.

65. The method of claim 64, wherein the mapping is based on power threshold and a layer 1 reference signal received power measurement associated with the one or more indicated TCI states.

66. The method of claim 64, wherein the managing the simultaneous transmissions further comprises:
in response to the mapping being a one-to-one mapping in which the one or more indicated TCI states each correspond to a different one of the one or more transmit antenna panels of the apparatus, considering the mapping as valid for use for the simultaneous transmission of the at least two uplink channels; and
otherwise considering the mapping as being invalid for use for the simultaneous transmission of the at least two uplink channels.
